(19) United States
(12) Patent Application Publication
(10) Pub. No.: US 2015/0178362 A1
(43) Pub. Date: Jun. 25, 2015

(54) Device-Group Snapshot

(71) Applicant: Aaron Wheeler, San Francisco, CA (US)

(72) Inventor: Aaron Wheeler, San Francisco, CA (US)

(73) Assignee: GOOGLE INC., Mountain View, CA (US)

(21) Appl. No.: 13/253,868

(22) Filed: Oct. 5, 2011

(51) Int. Cl. G06F 15/16; G06F 17/30; G06F 9/445

(52) U.S. Cl. CPC G06F 17/30575; G06F 9/44505

(57) ABSTRACT

Exemplary methods and system relate to creating a device group snapshot which allows the states of multiple devices to be stored and restored. A hub device may create a device group snapshot for a group of devices by detecting a change in context, selecting one or more devices from the device group to include in the device group snapshot, determining a state for each selected device, and storing a data record corresponding to the device group snapshot. The stored data record for the device group snapshot comprises an indication of the change context and a state record for each selected device. Each state record may include an identifier of the selected device, the determined state of the selected device, and an application state corresponding to the applications on the selected device.

### BACKGROUND

Unless otherwise indicated herein, the materials described in this section are not prior art to the claims in this application and are not admitted to be prior art by inclusion in this section.

Computing devices such as desktop computers, laptop computers, tablet computers, personal digital assistants, cellular phones, and countless types of Internet-capable devices are increasingly prevalent in numerous aspects of modern life. Typically, these computing devices have been designed to perform specific functions and in many instances, users simply prefer using certain computing devices over others when completing particular tasks. For example, many users prefer searching the web with a laptop rather than using a cell phone and alternatively, most people prefer using a cell phone to make phone calls as opposed to using a laptop. Consequently, the use of more than one device to complete a single task is ever-more common.

### SUMMARY

In one aspect, an exemplary system includes a non-transitory computer-readable medium and program instructions stored on the non-transitory computer-readable medium. The program instructions are executable by a processor to cause a hub device to: communicate with one or more other devices in a device group comprising the hub device and the one or more other devices; receive a data instruction to detect a change in context associated with a device-group snapshot, wherein the device-group snapshot comprises a state record for each of one or more of the devices in the device group; and responsive to receipt of the data instruction to detect the change in context associated with the device-group snapshot: (A) determine the change in context for the device-group snapshot; (B) select one or more devices from the device group to include in the device-group snapshot; (C) determine a state for each selected device; and (D) store a data record corresponding to the device-group snapshot, wherein the stored data record for the device-group snapshot comprises: (i) an indication of the change in context for the device-group snapshot and (ii) a state record for each selected device, wherein the state record comprises (a) an identifier of the selected device, (b) the determined state of the selected device, and (c) an application state corresponding to a respective state for each of one or more applications on the selected device.

In another aspect, an exemplary computer-implemented method may involve receiving a data instruction to detect a change in context associated with a device-group snapshot, wherein the device-group snapshot comprises a state record for each of one or more devices in a device group and responsive to receipt of the data instruction to detect the change in context associated with the device-group snapshot: (A) determining the change in context for the device-group snapshot; (B) selecting one or more devices from the device group to include in the device-group snapshot; (C) determining a state for each selected device; and (D) storing a data record corresponding to the device-group snapshot, wherein the stored data record for the device-group snapshot comprises: (i) an indication of the change in context for the device-group snapshot and (ii) a state record for each selected, wherein the state record comprises (a) an identifier of the selected device, (b) the determined state of the selected device, and (c) an application state corresponding to a respective state for each of one or more applications on the selected device.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1 is a block diagram illustrating a device group, according to an exemplary embodiment.

FIG. 2 is a flow chart illustrating a method for creating a device-group snapshot, according to an exemplary embodiment.

FIG. 3A is a block diagram illustrating a device-group snapshot, according to an exemplary embodiment.

FIG. 3B is a block diagram illustrating a device-group snapshot that may be created for device group of FIG. 1, according to an exemplary embodiment.

FIG. 4 is a flow chart illustrating a method for restoring a device-group snapshot, according to an exemplary embodiment.

FIG. 5 is a block diagram illustrating a cloud-based hub device coordinating the communication between with various devices, according to an exemplary embodiment.

FIG. 6 is a block diagram of a computing device, according to an exemplary embodiment.

FIG. 7A illustrates a wearable computing system according to an exemplary embodiment.

FIG. 7B illustrates an alternate view of the wearable computing system of FIG. 6A.

### DETAILED DESCRIPTION

Exemplary methods and systems are described herein. It should be understood that the word “exemplary” is used herein to mean “serving as an example, instance, or illustration.” Any embodiment or feature described herein as “exemplary” is not necessarily to be construed as preferred or advantageous over other embodiments or features. The exemplary embodiments described herein are not meant to be limiting. It will be readily understood that certain aspects of the disclosed systems and methods can be arranged and combined in a wide variety of different configurations, all of which are contemplated herein.

### A. Overview

Devices that enable users to save the state of various applications open on the device have gained popularity. However, the ability to save and resume work sessions in a previous state is typically limited to a single device. Since a user may rely on multiple devices to complete a given task, a user may want to save the state of a number of different devices in a common record, so that all the devices may be restored to their respective states at once. Accordingly, exemplary methods and systems may help a user create a “device-group snapshot” that captures the respective states of a number of different devices, and that can be restored at a later time.

An exemplary embodiment may allow the user to create a device-group snapshot by, for example, simply tapping a button on their cell phone. When the button is pressed, the cell phone may obtain state information for itself and a number of a user's other devices. For example, the cell phone may then create a device-group snapshot that includes state information for itself, the user's desktop computer, and the user's tablet computer. For instance, a device-group snapshot might indicate that: (a) a presentation is open in a presentation-viewing application on the desktop computer, (b) a file download is in progress to a certain storage location on the tablet computer, and (c) that the cell phone itself was engaged in a call with a particular phone number.

In addition, the cell phone may determine a change in context for the snapshot, which may be used for various purposes. For instance, the change in context may be used to intelligently determine which devices should be included in a snapshot, to determine when it is appropriate to create and/or to restore a snapshot, and/or to allow a user to readily identify which snapshot from a number of possible snapshots they would like to restore.

For instance, in the above example, the cell phone may determine that the user is in their office and include an indication that the snapshot is associated with an “office” context. Then, at a later time, the user may return to the user's home office. As such, the cell phone may detect a change in context to the “office” context and automatically restore the device-group snapshot associated with this context.

To restore the device-group snapshot, the cell phone may coordinate with the desktop computer to open the presentation the user was viewing previously (possibly to the slide the user was viewing when the device-group snapshot was created). In addition, the cell phone may coordinate with the tablet to wake up or turn on and resume downloading the large file (preferably from the point where the device state was saved and/or where downloading previously ceased). Alternatively, if the download completed in the background, the cell phone may coordinate with the tablet to open a folder where the file was stored and/or open the downloaded file with an appropriate application. Yet further, the cell phone may display the contact information for the user's work colleague, or possibly even place a call to the work colleague. As such, loading the device-group snapshot may help the user to quickly resume work on the project or task involving their desktop computer, tablet, and cell phone, which the user was working on when the device-group snapshot was created.

It should be understood that the above application of an exemplary embodiment is provided for illustrative purposes, and is just one of many possible applications of an exemplary embodiments.

### B. Exemplary Device Groups

An exemplary method may be carried out by a “hub device” in order to create a “device-group snapshot” for a “device group.” A hub device may be any computing device that is configured to receive state information from other devices in a device group, and to initiate creation of a device-group snapshot for the group. A device group may be any group of computing devices that are configured to provide state information, either directly or indirectly, to a common hub device. At a minimum, a device group includes two devices. For example, the device group may include the hub device and one or more other computing devices. Or, if the hub device is not part of a device group, the device group may include two or more computing devices. A device-group snapshot may be a data record that includes state information for devices in a device group.

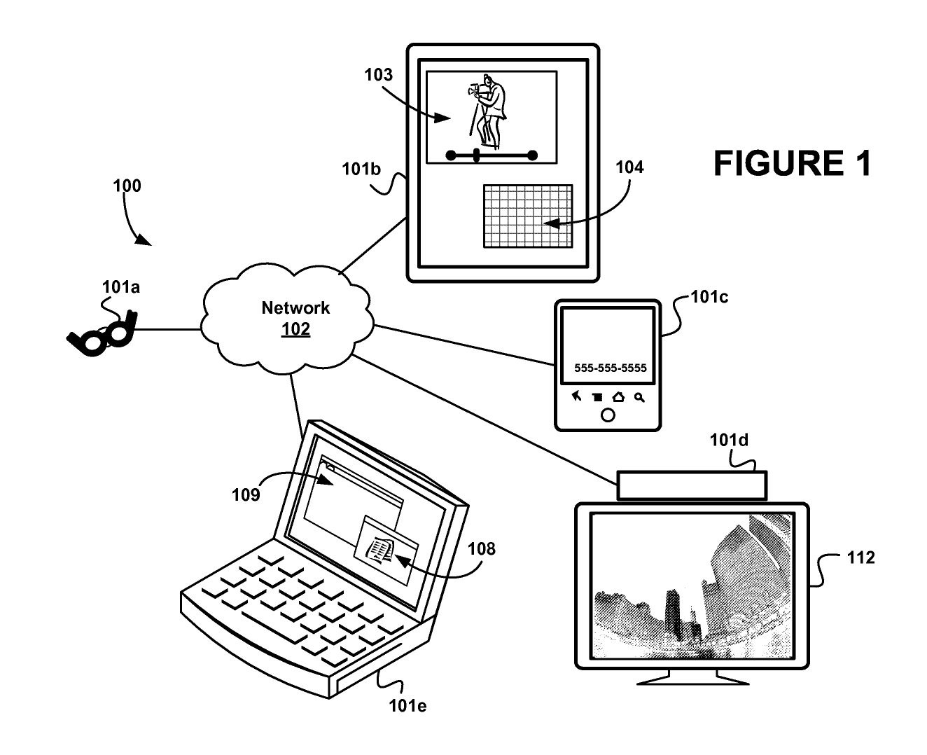

FIG. 1 is a block diagram illustrating a device group, according to an exemplary embodiment. As shown, the device group 100 includes a wearable computer 101a, a tablet computer 101b, a smartphone 101c, a television receiver 101d, and a laptop computer 101e. All the devices are configured to communicate via a network 102. It should also be understood that a device group may include various other types of devices, and generally may include any sort of computing device such as a network terminal, a printer, a desktop computer, and/or a set-top box, among others, without departing from the scope of the invention.

All the devices in device-group 100 may be configured to communicate with each other via a network 102. Alternatively, some devices in a device group may be configured to communicate with other devices in the device group via different networks and/or multiple networks.

Wearable computer 101a may be configured to serve as a “hub device” within device group 100. However, it should be understood that other devices in device group 100 may be configured to provide the hub-device functionality described herein, in addition or in the alternative to wearable computer 101a.

As the hub device for device-group 100, wearable computer 101a may implement an exemplary method in order to create a device-group snapshot. The device-group snapshot may include state records for some or all the devices in the device-group 100. For instance, when wearable computer 101a creates a device-group snapshot for device group 100, the snapshot may include state records for some or all of tablet computer 101b, smartphone 101c, television receiver 101d, and a laptop computer 101e.

### C. Exemplary Methods for Creating a Device-Group Snapshot

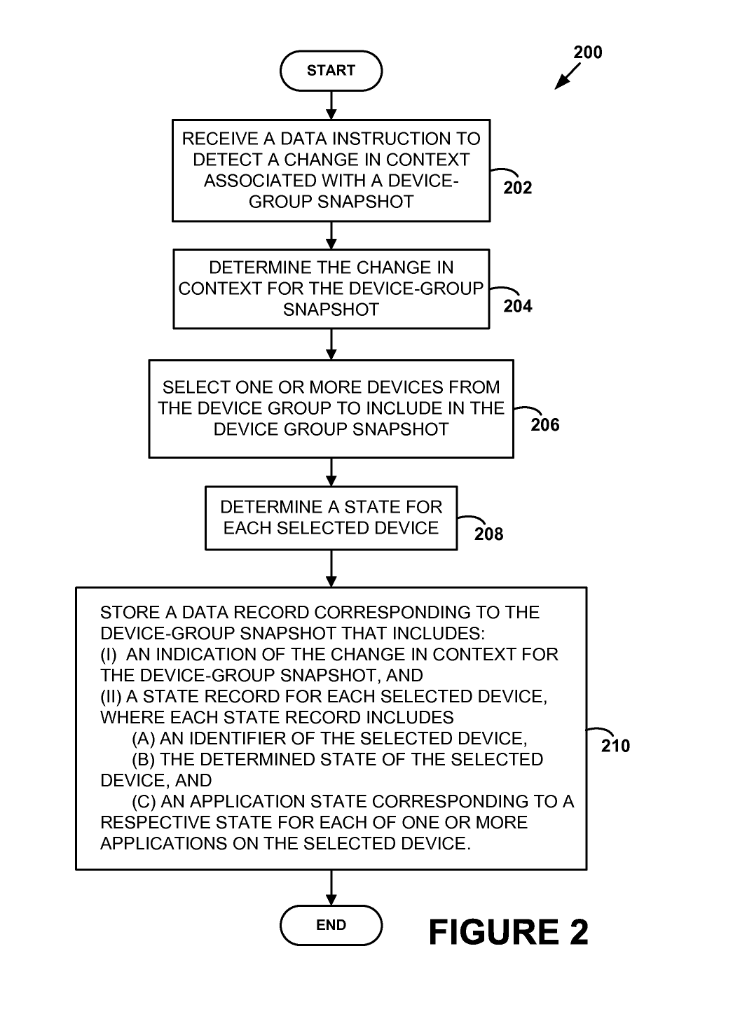

FIG. 2 is a flow chart illustrating a method for creating a device-group snapshot, according to an exemplary embodiment. Method 200 may be carried out by a hub device, such as wearable computer 101a, in order to create a device-group snapshot for a device group, such as device group 100.

As shown in FIG. 2, method 200 involves a hub device receiving a data instruction to create a device-group snapshot, as shown by block 202. The hub device then determines a change in context for the device-group snapshot, as shown in block 204. Yet further, the hub device proceeds to select one or more devices from the device group to include in the device-group snapshot, as shown by block 206. The hub device then determines a state for each selected device, as shown by block 208. The hub device may then store a data record corresponding to the device-group snapshot, which includes: (i) an indication of the change in context for the device-group snapshot and (ii) a state record for each selected device, as shown by block 210. As further shown by block 210, each state record may include: (a) an identifier of the selected device, (b) the determined state of the selected device, and (c) an application state corresponding to a respective state for each of one or more applications on the selected device.

i. Receive a Data Instruction to Create a Device-Group Snapshot

As noted above, block 202 of method 200 involves the hub device receiving a data instruction to detect a change in context associated with a device-group snapshot. The data instruction may take various forms and/or may be received from various sources.

In some embodiments, the data instruction to detect a change in context associated with a device-group snapshot can be made by the user. For example, wearable computer 101a may be configured to allow a user to request that a change in context be detected. As specific examples, the user may touch an icon on a touchscreen or select an icon in a GUI that is mapped to the function of detecting a change in context. In such a scenario, the device-group snapshot may be created in response to detecting the change in context corresponding to such user input.

ii. Determine a Change in Context for the Device-Group Snapshot

As noted above, block 204 of method 200 involves the hub device determining a change in context for the device-group snapshot. Generally, the determined change in context may be based on one or more “context signals.” Accordingly, a hub device may be configured to determine various context signals and/or to acquire context signals from other sources.

A context signal may be any signal that provides a measurement of or otherwise provides information pertaining to the state or the environment associated with a certain subject (e.g., with a certain person, device, event, etc.). Many types of information, from many different sources, may be used as context signals or provide information from which context signals may be determined. For example, context signals may include: (a) the current time, (b) the current date, (c) the current day of the week, (d) the current month, (e) the current season, (f) a time of a future event or future user-context, (g) a date of a future event or future user-context, (h) a day of the week of a future event or future context, (i) a month of a future event or future user-context, (j) a season of a future event or future user-context, (k) a time of a past event or past user-context, (l) a date of a past event or past user-context, (m) a day of the week of a past event or past user-context, (n) a month of a past event or past user-context, (o) a season of a past event or past user-context, ambient temperature near the user (or near a monitoring device associated with a user), (p) a current, future, and/or past weather forecast at or near a user's current location, (q) a current, future, and/or past weather forecast at or near a location of a planned event in which a user and/or a user's friends plan to participate, (r) a current, future, and/or past weather forecast at or near a location of a previous event in which a user and/or a user's friends participated, (s) information on user's calendar, such as information regarding events or statuses of a user or a user's friends, (t) information accessible via a user's social networking account, such as information relating a user's status, statuses of a user's friends in a social network group, and/or communications between the user and the users friends, (u) noise level or any recognizable sounds detected by a monitoring device, (v) items that are currently detected by a monitoring device, (w) items that have been detected in the past by the monitoring device, (x) items that other devices associated with a monitoring device (e.g., a “trusted” monitoring device) are currently monitoring or have monitored in the past, (y) information derived from cross-referencing any two or more of: information on a user's calendar, information available via a user's social networking account, and/or other context signals or sources of context information, (z) health statistics or characterizations of a user's current health (e.g., whether a user has a fever or whether a user just woke up from being asleep), and (aa) a user's recent context as determined from sensors on or near the user and/or other sources of context information, (bb) a current location, (cc) a past location, and (dd) a future location. Those skilled in the art will understand that the above list of possible context signals and sources of context information is not intended to be limiting, and that other context signals and/or sources of context information are possible in addition, or in the alternative, to those listed above.

Some context signals may take the form of discrete measurements. For example, a temperature measurement or a current GPS location may be used as a context signal. On the other hand, context signals may also be determined or measured over time, or may even be a continuous signal stream. For instance, an exemplary device may use the current volume of a continuous audio feed from an ambient microphone as one context signal, and the volume of a continuous audio feed from a directional microphone as another context signal.

In some embodiments, a “change in context” may be defined by changes between values of one or more context signals. Alternatively, a change in context may include deviations to a data-based description or modifications to the characterization of an environment or state that is determined or derived from one or more context-signals. For example, a change in context may take the form of data indicating changes to the environment or state information such as moving from “home” to “at work,” from “outside” to “in a car,” from “outdoors” to “indoors,” from “inside” to “outside,” from “free” to “in a meeting,” etc. In some instances, a change in context may indicate an action indicative of changes to the environment or state information such as “going to work,” “getting in the car,” “going inside,” “going outside,” “going to a meeting,” etc. Furthermore, a change in context may be a qualitative or quantitative indication that is determined based on one or more context signals. For example, context signals indicating a change in time to 6:30 AM on a weekday and that a user is located at their home may be used to determine the change in context such that the user went from “sleeping” to “getting ready for work.” In some instances, the change in context may be indicate a change to the environment or state information but may simply be reflected in a database as “going to work.”

In some instances, the determined change in context may simply be a label that the user provides for the snapshot. In this case, the hub device may, for example, determine the change in context from user-provided information that is included in the data instruction to detect a change in context associated with the device-group snapshot. For example, the hub device may determine the change in context from “subway” to “office” when the user leaves the subway station and arrives to their office. In some instances, the user may simply provide the text “going to office” in a context field of snapshot-creation GUI. Other examples are also possible.

In other instances, the change in context may be determined by the device. For instance, a hub device may determine, based on various context signals, that it has changed its location from the living room to the desk of a user that is associated with the hub device and/or with the device group. As such, the hub device may determine the change in context for the device-group snapshot to be from “living room” to “desktop.” Many other examples are also possible.

Associating changes in context with device-group snapshots may help a user to more easily identify which device-group snapshot they would like to load. For instance, if a user has stored device-group snapshots for changes in context associated with “leaving for work,” “driving to work,” “driving home from work,” and “arriving home,” a hub device may provide a GUI for loading previously-stored device-group snapshots, which lists the previously-stored device-group snapshots by the respective change in context. Accordingly, if the user wants to load the “leaving for work” change in context, the user may readily identify a device-group snapshot for the “leaving for work” change in context from a list of all previously-stored device-group snapshots.

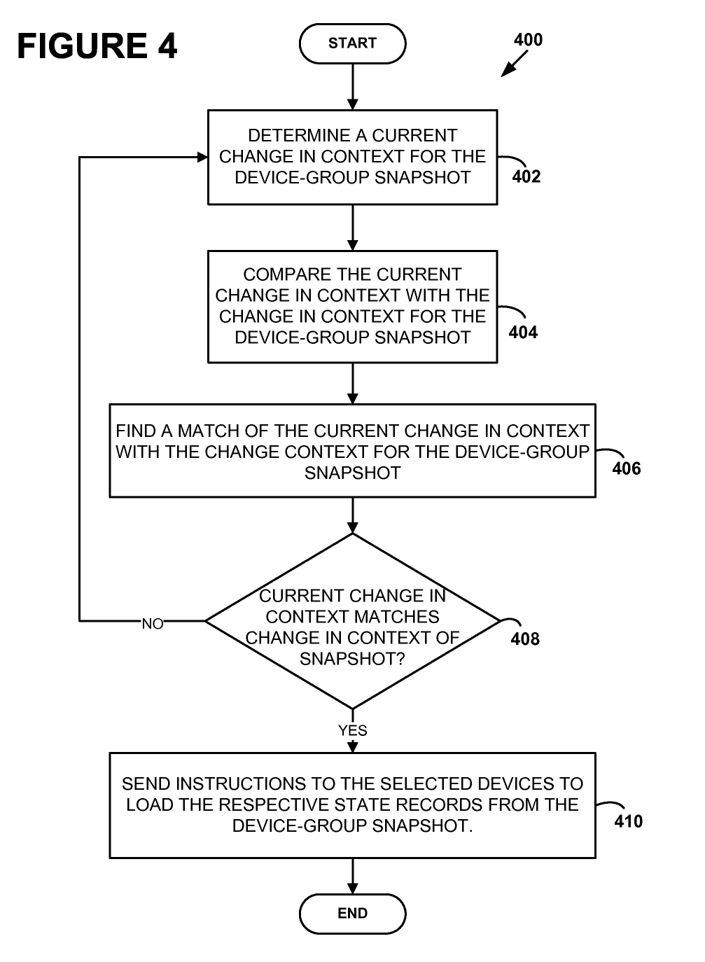

Further, associating changes in context with device-group snapshots may allow a hub device to intelligently load device-group snapshots when it determines that a current change in context matches the change in context corresponding to an existing device-group snapshot. This aspect is discussed in greater detail below with reference to FIG. 4.

iii. Selecting Devices for the Device-Group Snapshot

As noted above, block 206 of method 200 involves the hub device selecting one or more devices from the device group to include in the device-group snapshot. Referring to FIG. 1 as an example, wearable computer 101a may, in the process of creating a device-group snapshot, select one or more of tablet 101b, smartphone 101c, television receiver 101d and laptop computer 101e for inclusion in the snapshot. Referring back to method 200, the hub device may use various techniques to select devices for inclusion in a device-group snapshot, depending upon the particular implementation.

In some instances, the hub device may simply select all the devices in the device-group. Alternatively, the hub device may select all devices from which the hub device is able to determine state information. For example, a hub device may search for available devices in the device group (e.g., devices with which the hub device is able to communicate and receive state information from). The hub device may then send a state-information request to all devices with which it is able to establish communication, and select those devices that it successfully receives state information from.

In other instances, the hub device may select devices that the received data instruction indicates should be included in the snapshot. Referring again to FIG. 1 as an example, wearable computer 101a may receive an instruction to include itself and tablet 101b in the device-group snapshot, but exclude smartphone 101c, smart phone 101d, and laptop computer 101e. Accordingly the hub device may select itself and tablet 101b for the device-group snapshot. Many other examples are also possible.

To facilitate user selection of devices, a hub device may be configured to provide a user-interface that allows a user to specify devices that should be included in a device-group snapshot. For example, a hub device may search for available devices, and provide the user with a list of available devices in a snapshot-creation GUI. As a specific example, referring again to FIG. 1, consider a scenario where tablet 101b is damaged and is unable to function properly. In this case, the wearable computer 101a may provide the user with a list of devices that may be added in the snapshot. However, because tablet 101b is not functioning properly, wearable computer 101a may be unable to establish communication with and/or receive state information from tablet 101b. As such, tablet 101b may be left out of list of available devices that is displayed in a snapshot-creation GUI. Many other examples are also possible.

In some embodiments, a hub device may select the devices to include based on a change in context. In particular, it may be desirable to select certain devices and/or leave out certain devices depending on a particular change in context (or when different context signals are detected). For example, a hub device may include a desktop computer when the user enters their office, but leave out a home computer when it determines this particular change in context. Many other examples are also possible. To facilitate context-based selection of devices, a hub device may include or have access to context-to-device mapping data, which indicates certain devices that should be selected when a certain context signal or combination of context signals is detected.

In some embodiments, devices may not be selected unless an authentication mechanism has been implemented and passed. In particular of these embodiments, a hub device may only select devices that are “co-located” with the user, where an authentication mechanism has also been implemented and passed (perhaps with each device.) Example embodiments may involve a device's presence depending on geo location, WiFi beaconing, SSID reading, Bluetooth, and/or other near-field communication techniques. Other methods for selecting devices in a device group may be more generally based on detecting another device's presence (e.g., detecting the ability to communicate with a device). Detecting a device's presence through equivalent location technologies may include Enhanced Observed Time Difference (EOTD), Assisted GPS (A-GPS), Differential GPS (DGPS), Time Difference of Arrival (TDOA), Angle of Arrival, triangulation, monitoring of local transceiver pilot signals, and/or other technologies well-known in the art. In some embodiments, devices may be authenticated with user through mechanisms based on knowledge factors such as passwords, pass phrases, challenge responses, and/or personal identification numbers. Other mechanisms may include factors related to ownership such as wrist bands, ID cards, security tokens, software tokens, and/or keys.

iv. Creating and Storing a Device Group Snapshot

As shown by block 208 of method 200, after one or more devices have been selected for inclusion in a device-group snapshot, the hub device may determine the state of each selected devices, so that a state record for the device can be created. In an exemplary method, each state record includes (a) an identifier of the selected device, (b) the determined state of the selected device, and (c) an application state corresponding to a respective state for each of one or more applications on the selected device. A state record for a given device may include other data as well.

In some instances, a state record for a given device may include the respective states of applications that are open or running on the device. For instance, a state record corresponding to a certain application may: (a) identify a file or files that are open in and/or being accessed by the application, (b) indicate whether the application is minimized, maximized, or displayed in an application window, (c) indicate the size and/or position of the application window, (d) other application settings, and/or (e) other state information relating to the application.

As an example, the state record for a web-browser application may include state information indicating: (a) a URL that is open in the browser, (b) whether or not multiple tabs are open in the browser (and if so, which URLs are open in which tabs), (c) a browsing history, (d) favorite sites, (e) temporary internet files, (f) cookies, (g) form data, (h) passwords, (i) other settings of web browser, and/or (j) other state information relating to the web browser.

As another example, a state record for a word-processing application may include: state information indicating: (a) a file or files that are open and/or being edited in the application, (b) the size or position of a web-browser window, (c) page setup information, and/or (d) other user-configurable aspects corresponding to a word processing application.

State records may be created for virtually any type of application. For example, state records may also be created for spreadsheet applications, database management and access applications, presentation or slide show applications, e-mail applications, personal-information management applications, game applications, communication applications, shopping applications, web-browser-based applications, media playback and/or recording applications.

In some instances, a state record may also include state information related to the device itself, such as functionality of the device that is being utilized at the time the device-group snapshot is created. For example, the state record for a television receiver may include state information related to: (a) a television program that is being recording, (b) a television program that is being watched, (c) favorite channels, and/or (d) other state information related to the television receiver. Other examples are also possible.

In addition, a state record may also comprise information regarding the selected device, such as device settings or properties at the time the device-group snapshot is created. For instance, a state record may indicate a device's remaining battery life of the device, a device's ability to send and/or receive data, and/or an operating mode of the device (e.g., whether the device is on, off, in standby mode, sleep mode, or a busy mode). Further, a state record may indicate a device's network-connectivity status, bandwidth that is available to the device, a device's maximum available bandwidth, and/or other information related to devices network connectivity and capabilities.

Further, it should be understood that the above examples are provided for illustrative purposes, and that state records may include other state information without departing from the scope of the invention.

As indicated by block 210 of method 200, after determining a state for each selected device, the hub device may store a data record corresponding to the device-group snapshot. In an exemplary embodiment, the device-group snapshot includes: (i) an indication of the change in context for the device-group snapshot and (ii) a state record for each selected device. In a snapshot, the state record for a given device includes: (a) an identifier of the device, (b) the determined state of the device, and (c) an application state corresponding to a respective state for each of one or more applications on the selected device.

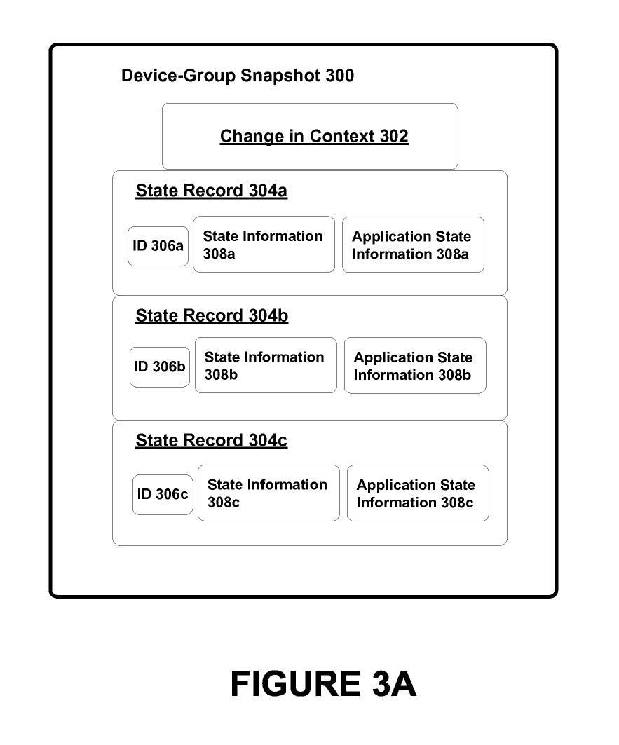

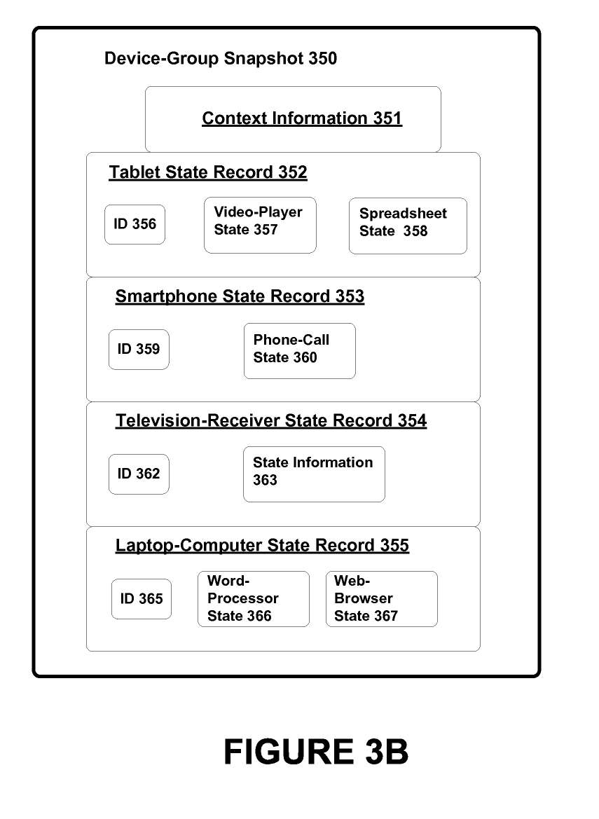

FIG. 3A is a block diagram illustrating a device-group snapshot, according to an exemplary embodiment. In particular, device-group snapshot 300 includes an indication of a change in context 302 and state records 304a, 304b, and 304c. Each state record 304a to 304c indicates the state of different device. In particular, each state record 304a to 304c includes a respective ID 306a to 306c for the respective corresponding device, as well as respective state information 308a to 308c for the respective corresponding device.

v. Application of an Exemplary Method to Create a Device-Group Snapshot

An exemplary application of method 200 will now be described with reference to device group 100 of FIG. 1. FIG. 1 illustrates a scenario where each device in device group 100 is in a certain state.

In particular, tablet 101b is playing a video in a video-player application 103. Additionally, tablet 101b has a spreadsheet document open in a spreadsheet application 104. Tablet 101b may also have other applications open, which are not shown in FIG. 1. For instance, other applications such as game applications, web-browsing applications, productivity applications, music and/or other media applications, and countless other types of applications may additionally or alternatively be open on tablet 101b.

At the same time as tablet 101b is in the above-described state, smartphone 101c may be engaged in a phone call with the phone number “555-555-5555.” In addition, the smartphone 101d may have various applications running in the background (not shown). For example, smartphone 101d may have a phone book application open in the background. Further, the phone book application may have a contact file open for the contact to whom the phone call was placed (e.g., the contact having the phone number “555-555-5555”). Other applications such as game applications, web-browsing applications, productivity applications, music and/or other media applications, and countless other types of applications may additionally or alternatively be open on tablet 101b.

Further, at the same time as tablet 101b and smartphone 101c are in the above-described states, television receiver 101d may be tuned to a particular television channel, which is being outputted for display on television set 112. Further, television receiver 101d may be tuned to another channel, which it is recording via a DVR application.

Yet further, at the same time as tablet 101b, smartphone 101c, and television receiver 101d are in the above-described states, laptop computer 101e may have a document open in a word-processor application 108. In addition, laptop computer 101e may have two tabs open in a web browser application 109. Each tab may be open to a different webpage (e.g., a different URL). Various other applications, in various other states, may also be open on laptop computer 101e.

In one application of an exemplary embodiment, the wearable computer 101 may create a device-group snapshot that includes state records corresponding to the above-described states of devices 101b-101e (and possibly a state record for itself as well). For example, FIG. 3B is a block diagram illustrating a device-group snapshot that may be created for device group of FIG. 1, according to an exemplary embodiment. More specifically, device-group snapshot 350 includes a tablet state record 352 (corresponding to the state of tablet 101b), smartphone state record 353 (corresponding to the state of smartphone 101c), television-receiver state record 354 (corresponding to the state of television receiver 101d), and laptop-computer state record 355 (corresponding to the state of laptop computer 101e). Device-group snapshot 350 also includes contextual information 351, which indicates the change in context that is associated with the device-group snapshot 350.

Each state record in device-group snapshot 350 includes a device identifier (ID), which uniquely identifies that device to which the record corresponds. In particular, tablet state record 352 includes a device ID 356, smartphone state record 353 includes a device ID 359, television-receiver state record 354 includes a device ID 362, and laptop-computer state record 355 includes a device ID 365.

Further, each state record in device-group snapshot 350 may include data indicating the state of the respective device when the snapshot was created. For example, tablet state record 352 includes video-player state information 357 (corresponding to the state of video player application 103) and spreadsheet state information 358 (corresponding to the state of spreadsheet application 104). The video-player state information 357 may indicate, for example, the identity and/or storage location of the particular video that was open, the time elapsed in the video, the time remaining in the video, the identity and/or storage location of a playlist including the video (if the video was being played in the course of playing back a playlist), and/or other state information relating to video-player application 103. The spreadsheet state information 358 may indicate, for example, the identity and/or storage location of the particular spreadsheet document that was open and/or other state information relating to spreadsheet application 104.

Further, smartphone state record 353 includes phone-call state information 360, which may indicate that smartphone 101c which engaged in a call to the phone number “555-555-5555” when the device-group snapshot 350 was created. Further, if the smartphone 101c had applications running in the background when the snapshot 350 was created, smartphone state record 353 may include state information (not shown) that indicates the respective states of these applications.

Yet further, television-receiver state record 354 includes state information 363 indicating the state of television receiver 101d at or near the creation of device-group snapshot 350. In particular, state information 363 may indicate the particular television channel that was being outputted for display on television set 112. For example, state information 363 may indicate, the channel number, the name of and/or information related to the particular program that was on the channel at the time, the elapsed and/or remaining time in the particular program, and possibly other information as well. Further, state information 363 may also include information related to the recording via the DVR application, such as the channel number and the name of and/or information related to the particular program that was being recorded.

And yet further, laptop-computer state record 355 includes word-processor state information 366 (corresponding to the state of word-processor application 108) and web-browser state information 367 (corresponding to the state of web-browser application 109). The word-processor state information 366 may indicate the particular document that is open in word-processor application 108 (e.g., the file name and/or the file storage location of the document), and possibly other state information related to word-processor application 108 as well. The web-browser state information 367 may indicate the URL of the webpage that is open in each tab of web-browser application 109, and possibly other state information related to web-browser application 109 as well.

vi. Automatically-Created Device-Group Snapshots

In some embodiments, a hub device may additionally or alternatively be configured to create a device-group snapshot automatically, rather than waiting for a user-instruction to do so. Further, a hub device may automatically create a device-group snapshot in various scenarios and/or for various reasons.

In one aspect, a hub device may automatically create and store a device-group snapshot when it detects a certain change in context. To facilitate this functionality, snapshot templates may be defined that specify what should be included when a device-group snapshot created. In particular, a snapshot template may identify the devices for which a state record should be included, and possibly the type of state information that should be included in each state record. Further, in order to determine which changes in context should trigger the creation of a snapshot, a hub device may include or have access to context-change-to-snapshot-template mapping data, which maps certain changes in context or context-change pairs to certain snapshot templates. As such, when a hub device detects a certain change in context, the hub device may use the context-change-to-snapshot-template mapping to determine whether a device-group snapshot should be automatically created for that change in context. As a specific example, a wearable computer acting as a hub device may detect that the current change in context from “in the office at 4:50 PM” to “outside the office at 4:55 PM” and responsively create a device-group snapshot to capture the states of devices associated with a user's work. In particular, the wearable computer may determine that the current context has changed from “in the office at 4:50 PM” to “outside the office at 4:55 PM” based on context signals such as: (a) a GPS location at or near a user's office, (b) detection of devices associated with a user's office (e.g., a desktop computer at the user's office), (c) the time of day changing to 4:55 PM, (d) the day of the week being a weekday, and/or (e) other context signals. The wearable computer may then determine, based on the context-change-to-snapshot-template mapping, that a device-group snapshot should be created that includes its own state, as well as state records for a work computer, a mobile phone, and a tablet computer. In this scenario, the hub device may automatically create a device-group snapshot for the “in the office at 4:50 PM” to “outside the office at 4:55 PM” change in context, which includes state records for itself, the work computer, the mobile phone, and the tablet computer.

In some embodiments, a hub device may receive instructions to detect a change in context from a first context to a second context and responsively create a device group snapshot. At any time after storing the data records for the device-group snapshot, the hub device may detect a change in context from the second context to the first context and load the respective state records from the device group snapshot. Furthermore, the hub device may be programmed to detect a change in context from any context to the first context and responsively load the state records for the device group snapshot. Yet further, after initially storing the data records for the device-group snapshot as described above, the hub device may refresh the determined states and application states of selected devices upon detecting a subsequent change in context from the first context to the second context.

For example, consider a wearable computer acting as a hub device and detecting a current change in context from “in the office” to “outside the office.” Responsively, the wearable computer may create a device-group snapshot to capture the states of devices associated with a user's work, which may include device states for a work computer, a mobile phone, a tablet computer, and the wearable computer. Further, contemplate that the user leaves the office with the mobile phone, tablet computer, and wearable device and continues operating these devices for other tasks while away from the office. At any later point in time, the user may return to the office and the wearable computer may detect a current change in context from “outside the office” to “in the office.” Responsively, the wearable computer may automatically load the device group snapshot such that the user may continue with the device states associated with the user's work when the user left the office. Alternatively, consider again that the user returns to the office and the wearable computer does not detect the current change in context to be from “outside the office” to “in the office.” Instead, the wearable computer may detect the change in context to be from “in the cafeteria” to “in the office.” Despite detecting a different change in context, the wearable computer may still load the device group snapshot such that the user may resume with the device states associated with the user's work when the user left the office.

In some instances, a wearable computer may frequently detect a specific change in context from “in the office” to “outside the office” and create a device-group snapshot. After creating a device-group snapshot for the first time to capture the states of devices associated with a user's work, the wearable computer may not re-create separate device-group snapshots upon detecting the change in context on a subsequent occurrence. Instead, the wearable computer may simply refresh the device group snapshot by updating the stored data records with the current state of each device. In some embodiments, updating the stored data records may include refreshing the state of the selected device and the application states on the selected device.

For example, consider a wearable computer acting as a hub device and a cell phone as a selected device in the device group snapshot. The wearable computer may detect the change in context from “in the office” to “outside the office” and save the cell phone's social networking app, contact list, and email account open at the time to the device group snapshot. Thereafter, the wearable computer may detect a subsequent change in context from “outside the office” to “in the office” and load the state of the cell phone saved to the device-group snapshot. Upon detecting another change in context from “in the office” to “outside the office,” the data records with the state of the cell phone may be refreshed with the current state of the cell phone. The current state of the cell phone may now include applications such as a web browser, call history, and text messaging. These new application states may refresh or overwrite the previous application states of the social networking app, contact list, and email account.

In some instances, a context-change pair may include a specific initial context and a generic subsequent context. In this case, the hub device may create a device-group snapshot based on the corresponding snapshot template whenever the context changes from the initial context to any subsequent context, regardless what the subsequent context is. In other instances, a context-change pair may include a specific initial context and one or more specific subsequent contexts. In this case, the hub device may only create a device-group snapshot based on the corresponding snapshot template when it detects a change from the initial context to a subsequent context that is specifically included in the context-change pair.

Further, an entry in the context-change-to-snapshot-template mapping may indicate a context that should be used for a device-group snapshot that is created from a certain snapshot template. For example, an entry may indicate that the context for a certain device-group snapshot should be the initial context from the entry's context-change pair. On the other hand, an entry could indicate that the context for a certain device-group snapshot should be a subsequent context from the entry's context-change pair. Other contexts may also be indicated by an entry in the context-change-to-snapshot-template mapping.

In some embodiments, when a hub device detects the initial context in a context-change pair, the hub device may determine the state information that is necessary to generate a device-group snapshot from the corresponding snapshot template. In particular, the hub device may pre-determine the state information when there is a possibility that the required state information may change or no longer be available once the context has changed.

As a specific example, it may be desirable to create a device-group snapshot that includes certain devices at a user's home, when a hub device detects a change in context from a context associated with the user being at home to a context associated with the user being away from home. For example, if a wearable computer acting as a hub device determines that a current context is “living room,” and the context-change-to-snapshot-template mapping indicates that a device-group snapshot should be created when a context change from the “living room” context to an “in car” context occurs, then the wearable may predetermine state information for devices indicated by the snapshot template corresponding to this context change. (Note that the wearable computer may determine this state information periodically, so that the state information will be reasonably up-to-date in the event the context change occurs.)

Accordingly, when the wearable computer detects a change from the “living room” context to the “in car” context, the wearable computer may use the predetermined state information to create a device-group snapshot based on the corresponding snapshot template. For instance, consider a scenario where the context-change-to-snapshot-template mapping maps this context change to a snapshot template that includes a television receiver in the living room and a user's laptop computer. In this scenario, the wearable computer may periodically determine the state of the laptop computer (e.g., application states on the laptop and so on) and the state of the television receiver (e.g., channel and/or program being viewed, elapsed and/or remaining time, and so on). Then, when the wearable computer detects a change from the “living room” context to the “in car” context, the wearable computer may automatically create a device-group snapshot using the predetermined state information.

The above examples of a hub device automatically creating a device-group snapshot are provided for illustrative purposes. It should be understood that a hub device may automatically create a device-group snapshot in other scenarios as well.

vii. Actions in Conjunction with the Creation of a Device-Group Snapshot

In a further aspect, a hub device may also initiate certain actions in conjunction with creating a device-group snapshot. Various types of actions are possible.

In some instances, a hub device may determine that the operating mode of a given one of the selected devices is different from an operating mode that is desired after creating a device-group snapshot, and responsively change the operating mode of the selected device to the desired operating mode. For instance, the hub device may switch between different operating modes such as: (i) an off mode, (iii) a normal operating mode, (iv) a standby mode, (v) a sleep mode, and (vi) a busy mode. Other operating modes are also possible.

As a specific example, consider the above example where a wearable computer detects a change from the “living room” context to the “in car” context. When the device-group snapshot is created in this scenario, it may be desirable to turn the living room television off since the user is no longer in the living room to watch the television. Accordingly, when the wearable computer creates the device-group snapshot, the wearable computer may also send instructions to the television receiver to power off the television. Further, if the user does not take their laptop with them, it may be desirable to put the laptop computer in a standby mode when the wearable computer detects the change from the “living room” context to the “in car” context. Accordingly, when the wearable computer creates the device-group snapshot, the wearable computer may also send instructions to the laptop to go into the standby mode.

In some embodiments, the hub device may store data or instruct another device to store data, to facilitate loading the device-group snapshot at a later time. For instance, continuing the above example, it may be desirable to instruct the television receiver to record the program when the wearable computer detects the change from the “living room” context to the “in car” context. By doing so, the program can be resumed from the point when the user left the living room, whenever the device-group snapshot is later restored. Accordingly, when the wearable computer creates the device-group snapshot, the wearable computer may also send instructions to the television receiver to start recording the television program.

The above examples of a hub device taking actions in conjunction with the creation of a device-group snapshot are provided for illustrative purposes. It should be understood that a hub device may take other types of action in conjunction with the creation of a device-group snapshot, without departing from the scope of the invention.

### D. Exemplary Methods for Restoring a Device-Group Snapshot

After the creation of the device-group snapshot, devices may be used for other purposes or may even be turned off. Then, at a later time, a hub device may receive an instruction to restore of the device-group snapshot, or determine that a device-group snapshot should be restored for another reason. (Note that the hub device that restores a device-group snapshot may be the same as or different from the hub device that created the device-group snapshot.) The hub device may then instruct the devices that are included in the snapshot to return to the respective state that is indicated by the snapshot. For instance, referring to FIG. 1 as an example, wearable computer 101a may send instructions, via network 102, to some or all of the devices in device-group 100, which indicate to load their respective states. Responsive to receiving these instructions, the devices may return their respectively indicated states.

FIG. 4 is a flow chart illustrating a method for restoring a device-group snapshot, according to an exemplary embodiment. As shown, method 400 involves a hub device determining a current change in context, as shown by block 402. Further, the hub device compares the current change in context with the change in context for the device-group snapshot, as shown in block 404. The hub device then determines whether the current change in context substantially matches the change in context for the device-group snapshot, as shown by block 406. If the current change in context substantially matches the change in context for the device-group snapshot, then the hub device sends instructions to the selected devices to load the respective state records from the device-group snapshot, as shown by block 408. If, on the other hand, the current change in context does not match the change in context for the device-group snapshot (or another device-group snapshot), the hub device may continue to periodically determine the current change in context in block 402 (or more generally, may monitor subsequent changes in context that match the change in context stored for the device-group snapshot).

A hub device may determine the current change in context in a number of ways. Generally, the hub device may determine the current change in context in a similar manner as it determines the change in context when creating a device-group snapshot; e.g., by determining context signals associated with the hub device and/or a user associated with the hub device, and deriving a change in context therefrom.

As a specific example, referring to wearable computer 101a as an example of a hub device, wearable computer 101a may determine that wearable computer's geographical location matches a location of the office building in which a user associated with the wearable computer works. Additionally or alternatively, the wearable computer 101a may determine that the current time is a time that the user is likely to be in their office (e.g., 10:30 AM on a Tuesday morning) and/or that an entry in the user's calendar application indicates they are going to be in their office at the current time. Based on these and possibly other context signals, wearable computer 101a may determine changes to these contexts to be, for example, “leaving work” and/or “arriving to the office.” Many other examples are also possible.

Once the hub device has determined the current change in context, the hub device may compare the current change in context to the change in context of the device-group snapshot. In practice, a number of device-group snapshots may have been created by the hub device carrying out method 400 and/or by other devices configured as hub devices. Accordingly, the hub device may include or have access to a database of device-group snapshots, which may index the device-group snapshots by changes in context (e.g., by changes in context signals and/or contexts derived from context signals). Therefore, in some embodiments, the function of comparing the current change in context to the change in context of the device-group snapshot, may actually involve comparing the current change in context to the change in contexts of a number of different device-group snapshots, in order to determine if any of the device-group snapshots has a substantially matching change in context. Accordingly, if a substantially matching change in context is found, the hub device may restore the device-group snapshot that corresponds to the matching changes in context.

Once the hub device finds a match, the hub device may send instructions to the selected devices to load the respective state records from the device-group snapshot. Herein, “loading” or “restoring” a device-group snapshot should be understood to involve a hub device sending instructions to one or more devices to revert to their respective states as indicated by the snapshot. For example, referring back to FIGS. 1 and 3B, wearable computer 101a may send instructions to devices 101b to 101e to return to their respective states as indicated by device-group snapshot 350. In particular, wearable computer 101a may instruct tablet 101b to return to the state indicated by state record 352, may instruct smartphone 101c to return to the state indicated by state record 353, may instruct television receiver 101d to return to the state indicated by state record 354, and may instruct laptop computer 101e to return to the state indicated by state record 355.

Further, loading or restoring a device-group snapshot may involve the hub device returning itself to a state indicated by the device-group snapshot. Yet further, in some instances, loading or restoring a device-group snapshot may involve the hub device sending data and/or files to another device (or instructing another device or system to send data and/or files to the other device), in order to facilitate the other device returning to the state indicated by the snapshot.

In some embodiments, a hub device may additionally or alternatively be configured to restore a device-group snapshot for reasons other than detecting that a current change in context matches snapshot's change in context. For example, a hub device may provide a GUI that allows a user to browse, load, and possibly even edit device-group snapshots. As such, a hub device may also load a device-group snapshot in response to a user's instruction to do so.

### E. Exemplary Cloud-Based Hub Device

In some embodiments, the hub device may take the form of a cloud-based server that coordinates between devices in a device-group. A cloud-based hub device may include a server or multiple servers communicating via a digital cloud or network. Yet further, each server computer may include a single computer, or a series of other computers, that link multiple computers or electronic devices together. In such an embodiment, the hub device, being a cloud-based server, may not be considered part of the device group.

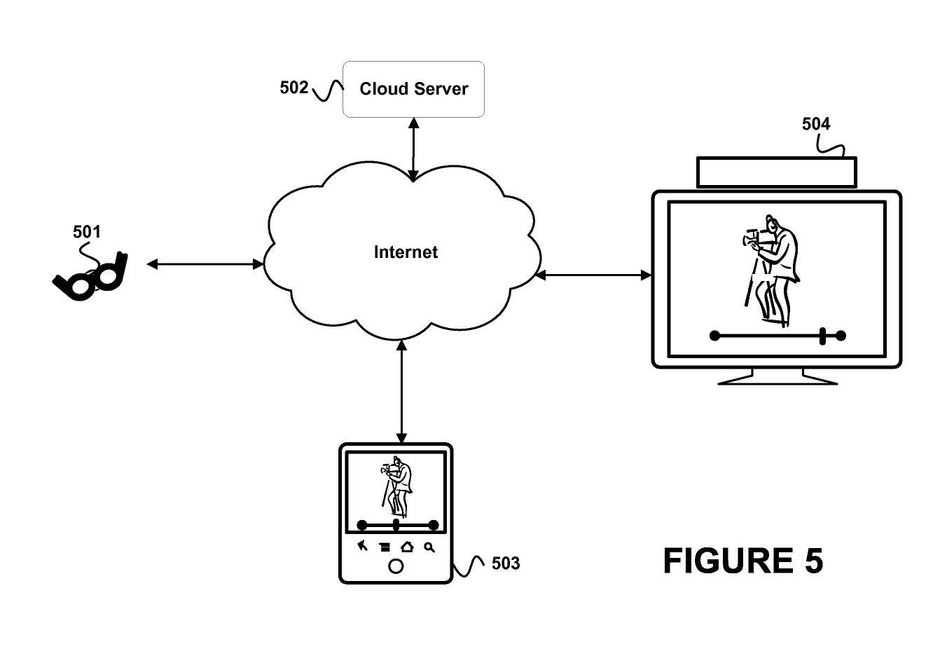

FIG. 5 is a block diagram illustrating a cloud-based hub device, according to an exemplary embodiment. In particular, FIG. 5 shows a cloud server 502 that is configured to coordinate to create a device-group snapshot for devices such as wearable computer 501, cellular phone 503, and television receiver 504.

More specifically, cloud server 502 may be configured to receive a request to create a device-group snapshot from wearable computer 501, cellular phone 503, and/or television receiver 504. Whether cloud server 502 may receive a request to create a device-group snapshot from a particular device may depend upon the capabilities of the particular device. Further, such a request may indicate the devices for which the snapshot should be created, or may provide information from which cloud server 502 may determine which devices to include in the snapshot.

When cloud server 502 receives a request to create a device-group snapshot, the cloud server may proceed to create a device-group snapshot. To do so, the cloud server 502 may request state information and/or context information from one or more of the devices for which the snapshot is being created. Additionally or alternatively, some or all of the state information and/or the context information may be provided in the request to create a device-group snapshot. In either case, once the cloud server 502 has determined the context for the snapshot and the state of each device to be included in the snapshot, the cloud server may create a device-group snapshot for the group of devices.

In a further aspect, the cloud server 502 may later receive a request to load a previously stored device-group snapshot. Accordingly, the cloud server 502 may coordinate with the devices indicated by the device-group snapshot to restore their respectively-indicated states.

### F. Exemplary Computing Devices

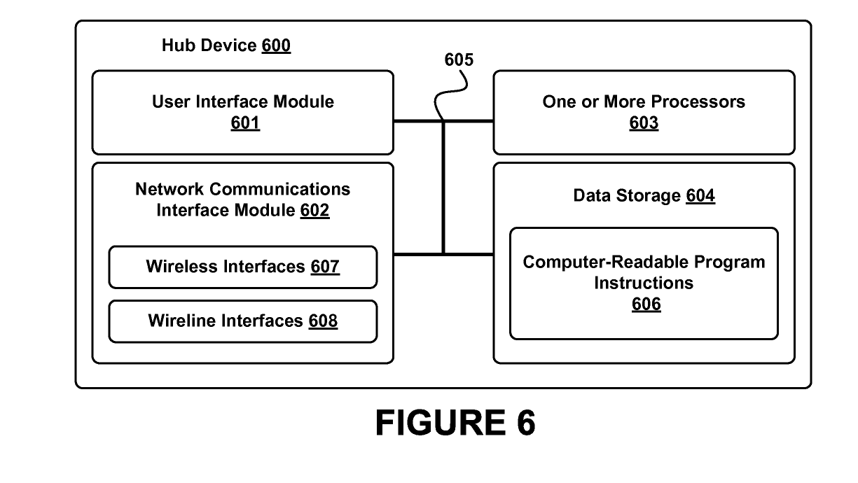

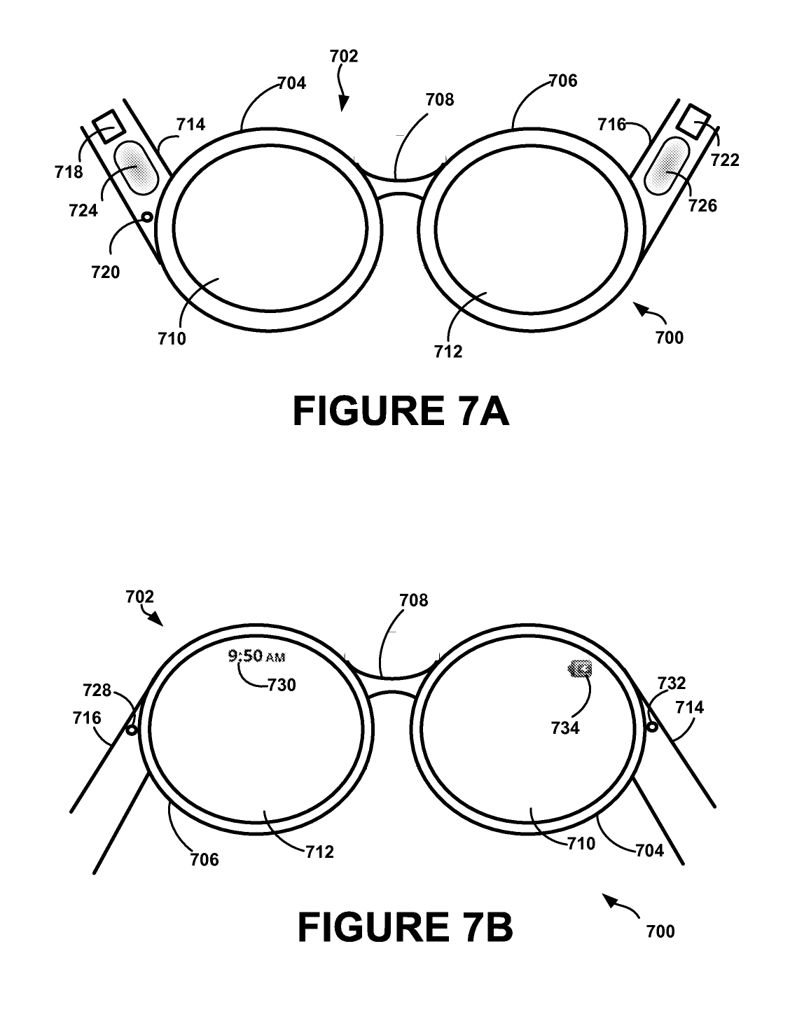

FIG. 6 is a block diagram of a computing device, according to an exemplary embodiment. Computing device 600 may be configured to function as a hub device, and thus may be configured to create and/or restore device-group snapshots. As shown, computing device 600 may include a user interface module 601, a network-communication interface module 602, one or more processors 603, and data storage 604, all of which may be linked together via a system bus, network, or other connection mechanism 605.

The user interface module 601 may be operable to send data to and/or receive data from external user input/output devices. For example, the user interface module 601 may be configured to send and/or receive data to and/or from user input devices such as a keyboard, a keypad, a touch screen, a computer mouse, a track ball, a joystick, a voice recognition module, and/or other similar devices, either now known or later developed. The user interface module 601 may also be configured to provide output to user display devices, such as one or more cathode ray tubes (CRT), liquid crystal displays (LCD), light emitting diodes (LEDs), displays using digital light processing (DLP) technology, printers, light bulbs, and/or other similar devices, either now known or later developed. The user interface module 601 may also be configured to generate audible output(s), such as a speaker, speaker jack, audio output port, audio output device, earphones, and/or other similar devices, either now known or later developed.

In order to create and/or restore a device-group snapshot, computing device 600 may be configured to communicate with a number of different devices in a device group, such as laptop computers, personal computers, personal assistant devices, set-top boxes, various types of cellular phones, and/or tablets, among others. These communications may be accomplished via network-communications interface module 602 (or possibly via multiple network-communications interface modules).

As such, the network-communications interface module 602 may include one or more wireless interfaces 607 and/or one or more wireline interfaces 608 that are configurable to communicate via a network. The wireline interfaces 608 may include one or more wireline transmitters, receivers, and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network. The wireless interfaces 607 may include one or more wireless transmitters, receivers, and/or transceivers, which allow the computing device 600 to communicate using various protocols such as Bluetooth, the various protocols described in IEEE 802.11 (including any IEEE 802.11 revisions), and/or cellular communication protocols (such as GSM, CDMA, UMTS, EV-DO, WiMAX, or LTE), radio-frequency identifier (RFID) protocols such as near-field communications (NFC), among other possibilities.

The one or more processors 603 may include one or more general purpose processors and/or one or more special purpose processors (e.g., digital signal processors, application specific integrated circuits, etc.). The one or more processors 603 may be configured to execute computer-readable program instructions 606 that are contained in the data storage 604 and/or other instructions as described herein.

The data storage 604 may include computer-readable program instructions 606 and perhaps additional data such that computing device 600 can carry out the hub-device functionality described herein. Further, data storage 604 may take the form of non-transitory computer-readable storage media that can be read or accessed by at least one of the processors 603. The one or more computer-readable storage media may include volatile and/or non-volatile storage components, such as optical, magnetic, organic or other memory or disc storage, which can be integrated in whole or in part with at least one of the processors 603. In some embodiments, the data storage 604 may be implemented using a single physical device (e.g., one optical, magnetic, organic or other memory or disc storage unit), while in other embodiments, the data storage 604 may be implemented using two or more physical devices.

As noted, in some embodiments, a hub device may take the form of a wearable computer (i.e., a wearable-computing device). In an exemplary embodiment, a wearable computer may take the form of or include a head-mounted display (HMD). However, an exemplary system may also be implemented in or take the form of other devices, such as a mobile phone, laptop or desktop computer, etc. Further, an exemplary system may take the form of non-transitory computer readable medium, which has program instructions stored thereon that are executable by at a processor to provide the functionality described herein. An exemplary, system may also take the form of a device such as a wearable computer or mobile phone, or a subsystem of such a device, which includes such a non-transitory computer readable medium having such program instructions stored thereon.

In an embodiment that includes an HMD, the HMD may generally be any display device that is worn on the head and places a display in front of one or both eyes of the wearer. An HMD may take various forms such as a helmet or eyeglasses. As such, references to “eyeglasses” herein should be understood to refer to an HMD that generally takes the form of eyeglasses. Further, features and functions described in reference to “eyeglasses” herein may apply equally to any other kind of HMD.

FIG. 6A illustrates a wearable computing system according to an exemplary embodiment. The wearable computing system is shown in the form of eyeglass 102. However, other types of wearable computing devices could additionally or alternatively be used. The eyeglasses 102 include a support structure that is configured to support the one or more optical elements.

In general, the support structure of an exemplary HMD may include a front section and at least one side section. In FIG. 6A, the support structure has a front section that includes lens-frames 604 and 606 and a center frame support 608. Further, in the illustrated embodiment, side-arms 614 and 616 serve as a first and a second side section of the support structure for eyeglasses 602. It should be understood that the front section and the at least one side section may vary in form, depending upon the implementation.

Herein, the support structure of an exemplary HMD may also be referred to as the “frame” of the HMD. For example, the support structure of eyeglasses 602, which includes lens-frames 604 and 606, center frame support 608, and side-arms 614 and 616, may also be referred to as the “frame” of eyeglasses 602.

The frame of the eyeglasses 602 may function to secure eyeglasses 602 to a user's face via a user's nose and ears. More specifically, the side-arms 614 and 616 are each projections that extend away from the frame elements 604 and 606, respectively, and are positioned behind a user's ears to secure the eyeglasses 602 to the user. The side-arms 614 and 616 may further secure the eyeglasses 602 to the user by extending around a rear portion of the user's head. Additionally or alternatively, for example, the system 600 may connect to or be affixed within a head-mounted helmet structure. Other possibilities exist as well.

In an exemplary embodiment, each of the frame elements 604, 606, and 608 and the side-arms 614 and 616 may be formed of a solid structure of plastic or metal, or may be formed of a hollow structure of similar material so as to allow wiring and component interconnects to be internally routed through the eyeglasses 602. Other materials or combinations of materials are also possible. Further, the size, shape, and structure of eyeglasses 602, and the components thereof, may vary depending upon the implementation.

Further, each of the optical elements 610 and 612 may be formed of any material that can suitably display a projected image or graphic. Each of the optical elements 610 and 612 may also be sufficiently transparent to allow a user to see through the optical element. Combining these features of the optical elements can facilitate an augmented reality or heads-up display where the projected image or graphic is superimposed over a real-world view as perceived by the user through the optical elements.

The system 600 may also include an on-board computing system 618, a video camera 620, a sensor 622, and finger-operable touchpads 624, 626. The on-board computing system 618 is shown to be positioned on the side-arm 614 of the eyeglasses 602; however, the on-board computing system 618 may be provided on other parts of the eyeglasses 602. The on-board computing system 618 may include a processor and memory, for example. The on-board computing system 618 may be configured to receive and analyze data from the video camera 620 and the finger-operable touchpads 624, 626 (and possibly from other sensory devices, user interfaces, or both) and generate images for output from the optical elements 610 and 612.

The video camera 620 is shown to be positioned on the side-arm 614 of the eyeglasses 602; however, the video camera 620 may be provided on other parts of the eyeglasses 602. The video camera 620 may be configured to capture images at various resolutions or at different frame rates. Many video cameras with a small form-factor, such as those used in cell phones or webcams, for example, may be incorporated into an example of the system 600. Although FIG. 6A illustrates one video camera 620, more video cameras may be used, and each may be configured to capture the same view, or to capture different views. For example, the video camera 620 may be forward facing to capture at least a portion of the real-world view perceived by the user. This forward facing image captured by the video camera 620 may then be used to generate an augmented reality where computer generated images appear to interact with the real-world view perceived by the user.

The sensor 622 is shown mounted on the side-arm 616 of the eyeglasses 602; however, the sensor 622 may be provided on other parts of the eyeglasses 602. The sensor 622 may include one or more of a gyroscope or an accelerometer, for example. Other sensing devices may be included within the sensor 622 or other sensing functions may be performed by the sensor 622.

In an exemplary embodiment, sensors such as sensor 622 may be configured to detect head movement by a wearer of eyeglasses 602. For instance, a gyroscope and/or accelerometer may be arranged to detect head movements, and may be configured to output head-movement data. This head-movement data may then be used to carry out functions of an exemplary method, such as method 600, for instance.

The finger-operable touchpads 624, 626 are shown mounted on the side-arms 614, 616 of the eyeglasses 602. Each of finger-operable touchpads 624, 626 may be used by a user to input commands. The finger-operable touchpads 624, 626 may sense at least one of a position and a movement of a finger via capacitive sensing, resistance sensing, or a surface acoustic wave process, among other possibilities. The finger-operable touchpads 624, 626 may be capable of sensing finger movement in a direction parallel or planar to the pad surface, in a direction normal to the pad surface, or both, and may also be capable of sensing a level of pressure applied. The finger-operable touchpads 624, 626 may be formed of one or more transparent or transparent insulating layers and one or more transparent or transparent conducting layers. Edges of the finger-operable touchpads 624, 626 may be formed to have a raised, indented, or roughened surface, so as to provide tactile feedback to a user when the user's finger reaches the edge of the finger-operable touchpads 624, 626. Each of the finger-operable touchpads 624, 626 may be operated independently, and may provide a different function.

FIG. 6B illustrates an alternate view of the wearable computing system of FIG. 6A. As shown in FIG. 6B, the optical elements 610 and 612 may act as display elements. The eyeglasses 602 may include a first projector 628 coupled to an inside surface of the side-arm 616 and configured to project a display 630 onto an inside surface of the optical element 612. Additionally or alternatively, a second projector 632 may be coupled to an inside surface of the side-arm 614 and configured to project a display 634 onto an inside surface of the optical element 610.

The optical elements 610 and 612 may act as a combiner in a light projection system and may include a coating that reflects the light projected onto them from the projectors 628 and 632. In some embodiments, a special coating may not be used (e.g., when the projectors 628 and 632 are scanning laser devices).

In alternative embodiments, other types of display elements may also be used. For example, the optical elements 610, 612 themselves may include: a transparent or semi-transparent matrix display, such as an electroluminescent display or a liquid crystal display, one or more waveguides for delivering an image to the user's eyes, or other optical elements capable of delivering an in focus near-to-eye image to the user. A corresponding display driver may be disposed within the frame elements 604 and 606 for driving such a matrix display. Alternatively or additionally, a laser or LED source and scanning system could be used to draw a raster display directly onto the retina of one or more of the user's eyes. Other possibilities exist as well.

While FIGS. 6A and 6B show two touchpads and two display elements, it should be understood that many exemplary methods and systems may be implemented in wearable computing devices with only one touchpad and/or with only one optical element having a display element. It is also possible that exemplary methods and systems may be implemented in wearable computing devices with more than two touchpads.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A system comprising:
a non-transitory computer-readable medium; and
program instructions stored on the non-transitory computer-readable medium and executable by a processor to cause a hub device to:
communicate with one or more other devices in a device group comprising the hub device and the one or more other devices;
detect a change in context associated with the hub device, wherein the change in context comprises a change from a first context to a second context; and
responsive to the detection of the change in context:
select one or more devices from the device group to include in a device-group snapshot, wherein the one or more devices are selected based at least in part on mapping data that maps certain devices to certain context changes, and wherein the one or more devices includes the hub device;
determine a state for each selected device; and
store a data record corresponding to the device-group snapshot, wherein the stored data record for the device-group snapshot comprises: (i) an indication that the device-group snapshot is associated with the first context, and (ii) a state record for each selected device, wherein the state record comprises (a) an identifier of the selected device and (b) the determined state of the selected device, wherein the determined state of the selected device comprises an indication of an operating mode of the selected device.

2. The system of claim 1, wherein the hub device comprises a head-mounted display (HMD), wherein the HMD comprises a side-mounted touchscreen.

3. The system of claim 1, wherein the program instructions stored on the non-transitory computer-readable medium and executable by the processor further causes the hub device to receive a data instruction to detect the change in context associated with the hub device, wherein the data instruction further comprises an indication to select the one or more devices, and wherein the indicated devices are selected as the one or more devices to include in the device-group snapshot.

4. The system of claim 1, wherein the program instructions stored on the non-transitory computer-readable medium and executable by the processor to cause the hub device to select the one or more devices from the device group to include in the device-group snapshot further causes the hub device to:
determine that one or more other devices in the device group are present; and
select the one or more present devices as the one or more devices from the device group to include in the device-group snapshot.

5. The system of claim 1, wherein the one or more selected devices comprise the hub device and one or more other devices in the device group.

6. The system of claim 1, wherein the program instructions stored on the non-transitory computer-readable medium and executable by the processor further causes the hub device to receive a data instruction to detect the change in context associated with the hub device, wherein the data instruction comprises an indication of the change in context from the first context to the second context.

7. The system of claim 1, wherein the hub device is configured to select the one or more devices in the device group and include each determined state of the one or more selected devices in the device group snapshot based on the determination of the first context.

8. The system of claim 1, wherein the hub device is configured to select the one or more devices in the device group and include each determined state of the one or more selected devices in the device group snapshot based on the determination of the second context.

9. The system of claim 1, wherein the change in context for the device-group snapshot is determined based on one or more context signals, wherein the one or more context signals comprise an indication of one or more of the following: (a) a current time, (b) a current date, (c) a current day of the week, (d) a current month, (e) a current season, (f) a time of a future event or future context, (g) a date of a future event or future context, (h) a day of the week of a future event or future context, (i) a month of a future event or future user-context, (j) a season of a future event or future context, (k) a time of a past event or past context, (l) a date of a past event or past context, (m) a day of the week of a past event or past context, (n) a month of a past event or past context, (o) a season of a past event or past context, (p) ambient temperature, (q) a current, future, or past weather forecast at a current location, (r) a current, future, or past weather forecast at a location of a planned event, (s) a current, future, or past weather forecast at or near a location of a previous event, (t) information on a calendar associated with the user-profile, such as information regarding events or statuses of a user or a user's friends, (u) information accessible via a user's social networking account, such as information relating a user's status, statuses of a user's friends in a social network group, and/or communications between the user and the users friends, (v) noise level or any recognizable sounds detected by a device, (w) items that are currently detected by a device, (x) items that have been detected in the past by the device, (y) items that other devices associated with a device are currently in communication with or have communicated with in the past, (z) information derived from cross-referencing any two or more of: information on a user's calendar, information available via a user's social networking account, and/or other context signals or sources of context information, (aa) health statistics or characterizations of a user's current health, (bb) a user's recent context as determined from sensors on or near the user and/or other sources of context information, (cc) a current location, (dd) a past location, and (ee) a future location.

10. The system in claim 1, wherein the state record for at least one selected device comprises an indication of one or more of the following: (a) remaining battery life of the device; (b) ability to send and receive data; (c) an application state corresponding to the respective state for each of the one or more applications on the at least on selected device, (d) system settings of the selected device, and (e) state information corresponding to system functions of the selected device, (f) network-connectivity status, (g) current available bandwidth for data communications; and (h) maximum available bandwidth for data communications.

11. The system of claim 1, wherein the operating mode comprises one of the following: (i) off mode, (ii) normal operating mode, (iii) standby mode, (iv) sleep mode, and (v) busy mode.

12. The system of claim 1, further comprising program instructions stored on the non-transitory computer-readable medium and executable by a processor to, responsive to receipt of a data instruction to detect the change in context associated with a device-group snapshot:
determine that the operating mode of the selected device is different from a desired operating mode corresponding to the change in context; and
change the operating mode of the selected device to the desired operating mode.

13. The system of claim 1, wherein at least one of the selected devices is a video player capable of processing media data, wherein an application state of the video player further indicates progress made in processing the media data at or near receipt of the program instructions.

14. The system of claim 1, wherein at least one of the selected devices is a personal computer, wherein an application state of the personal computer further indicates files that are open on the personal computer.

15. The system of claim 1, wherein at least one of the selected devices is a cell phone, wherein an application state of the cell phone further indicates mobile applications open on the cell phone.

16. The system of claim 1, wherein the hub device is a cloud-based device configured to communicate with the one or more other devices in the device group comprising the hub device and the one or more other devices.

17. The system of claim 1, wherein the determined state of at least one of the selected devices comprises an indication of at least one of the following:
network-connectivity status;
current available bandwidth for data communications; and
maximum available bandwidth for data communications.

18. The system of claim 1, wherein the program instructions are further executable by a processor to cause a hub device to, after storing the data record for the device-group snapshot:
detect a current change in context from the second context to the first context; and
send instructions to the selected devices to load the respective state records from the device-group snapshot.

19. The system of claim 18, wherein responsive to the current change in context, the hub device is configured to send instructions to at least one of the selected devices to buffer data associated with the state indicated in the state record for the selected device.

20. A computer-implemented method comprising:
communicating with one or more other devices in a device group comprising the hub device and the one or more other devices;
detecting a change in context associated with the hub device, wherein the change in context comprises a change from a first context to a second context; and
responsive to the detection of the change in context:
selecting one or more devices from the device group to include in a device-group snapshot, wherein the one or more devices are selected based at least in part on mapping data that maps certain devices to certain context changes, and wherein the one or more devices includes the hub device;
determining a state for each selected device; and
storing a data record corresponding to the device-group snapshot, wherein the stored data record for the device-group snapshot comprises: (i) an indication that the device-group snapshot is associated with the first context and (ii) a state record for each selected device, wherein the state record comprises (a) an identifier of the selected device and (b) the determined state of the selected device, wherein the determined state of the selected device comprises an indication of an operating mode of the selected device.

21. The method of claim 20, wherein the computer-implemented method is performed by a head-mountable display (HMD), and wherein the HMD is configured to detect movement of the HMD while the HMD is head-mounted.

22. The method of claim 20, wherein the change in context from the first context to the second context comprises a change in location from a first location to a second location.

23. The method of claim 20, wherein after storing the data record for the device-group snapshot, the method further comprises:
detecting a current change in context from the second context to the first context; and
responsive to detecting the current change in context, sending instructions to at least one of the selected devices to load the respective state records from the device-group snapshot.

24. The method of claim 20, wherein after storing the data record for the device-group snapshot, the method further comprises:
detecting a current change in context from a third context to the second context; and
responsive to detecting the current change in context, sending instructions to at least one of the selected devices to load the state records for the selected devices.

25. The method of claim 20, wherein after storing the data record for the device-group snapshot, the method further comprises:
detecting a current change in context from the first context to the second context; and
responsive to detecting the current change in context from the first context to the second context:
determining a current state for each selected device; and
updating the stored data record with the current state for each selected device.

26. The method of claim 25, wherein updating the stored data record with the current state for each selected device comprises:
(a) refreshing the determined state of the selected device, and (b) refreshing an application state corresponding to the respective state for each of one or more current applications on the selected device.
